(19) United States
(12) Patent Application Publication
(10) Pub. No.: US 2016/0016110 A1
(43) Pub. Date: Jan. 21, 2016

(54) STEAM CONDITIONER-SEPARATOR APPARATUS

(71) Applicant: Antonio MUÑOZ SEGURA, Viladecans (ES)

(72) Inventor: Antonio MUÑOZ SEGURA, Viladecans (ES)

(21) Appl. No.: 14/802,265

(22) Filed: Jul. 17, 2015

(30) Foreign Application Priority Data
Jul. 17, 2014 (EP) 14382281.5

(51) Int. Cl. B01D 53/26; F22B 37/26

(52) U.S. Cl. CPC B01D 53/265; F22B 37/26; B01D 53/266

(57) ABSTRACT

The present invention relates to a device for treating-separating water vapour aimed at eliminating the condensed particles that may be carried over therewith as it flows through the ducts, as well as the droplets suspended therein, thereby obtaining practically dry vapour, improving its quality, without additional energy input.

### FIELD OF THE ART

The present invention relates to a water vapour conditioning-separating device aimed at eliminating the condensed particles carried over with said vapour through ducts and the droplets suspended therein, thereby obtaining practically dry vapour, improving its quality, without need for additional energy input.

### STATE OF THE ART

Only one type of water vapour separator is known in the state of the art, which only eliminates the liquid formations carried over with the vapour as it flows through the different ducts that form the facility, not eliminating the droplets contained therein.

This increases energy costs due to the fact that the calorific value of the vapour is decreased when carrying part of the water suspended. The water vapour conditioning-separating device of the present invention allows all the heat to return to its original state, which is called vapour enthalpy.

### DESCRIPTION OF THE INVENTION

The present invention relates to a water vapour conditioning-separating device aimed at eliminating the condensed particles carried over with the vapour as it flows through the ducts that transport it, as well as the droplets suspended therein, thereby obtaining practically dry vapour, improving its quality, without need for additional energy input.

The water vapour conditioning-separating device comprises a condensation tank or chamber whereto a vapour transport duct is tangentially connected from a vapour generator or accumulator. Additionally, a dry vapour extraction duct axially passes through the tank, from the upper part thereof and without reaching the lower part, whereupon a filtering mass determining a labyrinthine passage for the vapour is disposed at a certain height inside the condensation tank or chamber and is contained within a minimum of two perforated plates which allow circulation therethrough of the vapour to be treated. Another perforated plate having inclined walls is eventually disposed under the described assembly and above the level of the lower inlet of the treated vapour extraction or outlet duct, for collecting and condensing the last water particles, particularly when there is a relatively high vapour flow rate.

The lower part of the tank ends in a funnel-shaped bottom having an outlet duct and, optionally, a purge valve to eliminate condensates.

Further, the orifices of all the perforated plates, both those that maintain the labyrinthine filtering mass and those having inclined walls, are preferably formed by punching, in such a manner as to form protruding necks wherein the material is irregularly broken, forming irregular edges that determine droplet condensation points, wherein the aforementioned necks in the plates containing the filtering mass are disposed in the direction of circulation of the vapour and, in the plate having inclined walls, in the opposite direction, precisely to prevent the last condensations formed thereon from passing through the perforations of the plate.

Likewise, all of the aforementioned perforated plates have an irregular contour with recesses, notches or similar defining peripheral passages of the condensates, which can slide down the walls of the condensation tank or chamber, without necessarily having to pass through the orifices of said plates.

The fact that the orifices of the perforated plate having inclined walls do not have irregular edges barely affects the retention of the condensates, as their only mission is that of increasing the contact surface with the circulating vapour and forcing the condensates formed on said surface to slide down the walls of the condensation chamber.

Optionally, the lower end of the dry vapour extraction duct is bevelled, avoiding a possible suction effect on the body of water accumulated at the bottom of the condensation tank or chamber until the moment of purging thereof.

In summary, the invention relates to a water vapour conditioning-separating device comprising a tank that acts as a condensation chamber, characterised in that it comprises a vapour inlet duct disposed on the upper part of the tank, where the vapour inflow to the tank is carried out tangentially to the wall of said device, flowing into an upper expansion enclosure of said tank, where the upper expansion enclosure is closed along the bottom by a filtering mass contained between the two first perforated plates that jointly determine, together with the filtering mass, a labyrinthine passage for the circulating vapour, in addition to comprising a treated vapour extraction duct that passes through the assembly formed by the filtering mass and the perforated plates.

The water vapour conditioning-separating device of the present invention allows the obtainment of dry saturated vapour with a quality=1 (from 0.98% to 1%) with absence of water particles in liquid state, improving the performance of heat transfer in all the production processes that use it, either directly to the product or indirectly.

This dry saturated vapour substantially improves heat transfer performance in all direct and also indirect exchange processes wherein, on mixing it with the product or medium to be treated, it is evenly distributed.

The water vapour conditioning-separating device eliminates the water that may be produced by boiler carryover and the water condensed by the vapour throughout the pipes of the facility, but its principal quality consists of eliminating the water microparticles in liquid state carried over with the vapour at high speed.

In order to eliminate these liquid water microparticles, the device centrifuges the vapour at the inlet, thereby separating the largest droplets, which are removed by gravity from the vertical walls to the bottom of the body, the smallest of which are filtered and aggregated by means of the perforated plates and the labyrinthine filtering mass, which separates them from the vapour and, by gravity, likewise fall to the bottom of the body, where they are eliminated by means of a purge valve.

### BRIEF DESCRIPTION OF THE DRAWINGS

In order to complement the description being made and with the object of helping to better understand the characteristics of the invention, in accordance with a preferred embodiment thereof, said description is accompanied, as an integral part thereof, by a set of drawings where, in an illustrative and non-limiting manner, the following has been represented:

FIG. 1 shows an elevational view and axial cross-section of the water vapour conditioning-separating device of the present invention.

FIG. 2 shows a plan view of the water vapour conditioning-separating device of the present invention.

FIG. 3 shows a detailed view, at larger scale, of the perforations of the internal plates of the water vapour conditioning-separating device of the present invention.

FIG. 4 shows a cross-sectional view taken along IV-IV of FIG. 1.

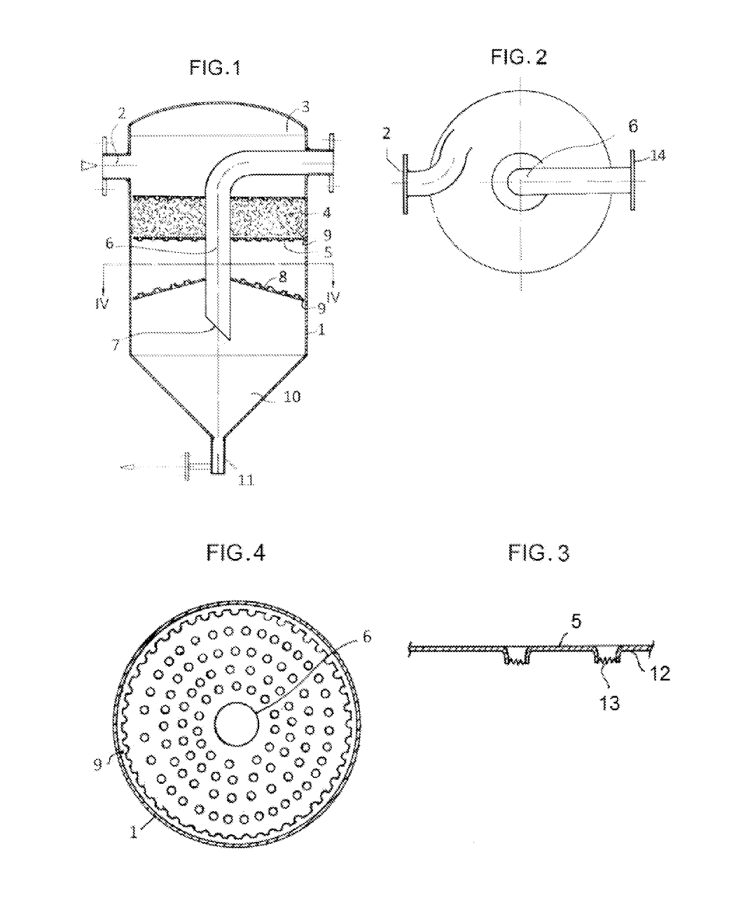

### DETAILED DESCRIPTION OF THE INVENTION

In accordance with the invention, the water vapour conditioning-separating device comprises a cylindrical frustoconical shaped tank (1) which acts as a condensation chamber, a vapour inlet duct (2) disposed on the upper part of the tank (1) wherein the vapour inflow to the tank is carried out tangentially to the cylindrical wall of said tank (1), flowing into an upper expansion enclosure (3) of said tank (1), wherein the upper enclosure (3) is closed along the bottom by a filtering mass (4) contained between two first perforated plates (5), whereupon the upper enclosure (3), the filtering mass (4) and the first perforated plates (5) jointly determine a labyrinthine passage for the circulating vapour where the greatest condensation of water particles carried over with said vapour is produced.

The water vapour conditioning-separating device also comprises a second perforated plate (8) having inclined walls sloping downward towards the walls of the tank (1), the second perforated plate (8) being disposed under the other two perforated plates (5).

The perforated plates (5, 8) comprise a series of notches (9) along their peripheral edge which may also be simple irregularities along their contour, to allow the condensed water to slide down the walls of the tank (1) towards the bottom thereof.

The tank (1) comprises a funnel (10) at the bottom thereof (1), which corresponds to the abovementioned frustoconical shaped part thereof (1) and a purge duct (11) adjacently disposed to the funnel (10), in such a manner that a manual or automatic purge valve may be coupled to the purge duct (11) to eliminate the condensed water.

The (8) water vapour conditioning-separating device also comprises a treated vapour extraction duct (6) that vertically passes through the assembly formed by the filtering mass (4) and the perforated plates (5, 8), wherein the vapour extraction duct (6) comprises a lower bevelled end (7) disposed at a certain distance from the bottom of the tank (1) and an upper end (14) wherethrough dry vapour flows out, preferably disposed in diametrical opposition to the vapour inlet duct (2).

The perforated plates (5, 8) comprise orifices which, in turn, comprise protruding necks (12) having irregular edges that form points (13) that determine condensate drop formation spots, wherein said orifices of the perforated plates (5, 8) may be formed by simple punching of the constituent material thereof (5, 8), whereupon the irregular edges are formed by breakage of the material, as can be observed in FIG. 3.

The protruding necks (12) of the orifices of the first perforated plates (5) are disposed under the first perforated plates (5) in the direction of circulation of the vapour, whereas the protruding necks of the second perforated plate (8) are disposed above the second perforated plate (8) in the opposite direction, thereby determining a greater contact surface and facilitating the condensation of the last remnants of water.

The filtering mass (4) comprises a material that is unalterable regardless of changes in humidity, such a sponge made of stainless steel, plastic material or other, having the necessary structure to determine the abovementioned labyrinthine passage mentioned.

In other embodiments, there may be more than two first perforated plates (5); likewise, there may be more than one second perforated plate (8), although there may likewise not be any second perforated plate (8) at all, in accordance with the larger or smaller volume of vapour to be treated.

Following is a description of the operation of the (8) water vapour conditioning-separating device of the present invention.

The vapour produced by a conventional generator or accumulator penetrates through the vapour inlet duct (2) and, due to the tangential position thereof, has a centrifugal effect thereon in the manner of a cyclone or turbine, while simultaneously undergoing expansion in the interior of the upper enclosure (3). This effect causes the vapour, on coming into contact with the walls of the tank (1) in the area of said upper enclosure (3), to condense and a large portion of the water to be deposited on said walls which, sliding down said walls and aided by the peripheral passages of the perforated plates (5, 8) formed by the notches (9), flows directly towards the funnel (10) disposed at the bottom of the tank (1), where it is accumulated.

The rest of the vapour is forced to pass through the filtering mass (4) contained between the first perforated plates (5), between which filtering mass (4) said rest of the vapour will condense and another large portion of the water particles carried over will be retained, contributing to the formation of drops on the points (13) of the protruding necks (12) of the orifices of the first perforated plates (5).

The resulting vapour, practically free from liquid particles, is finally forced to pass through the second perforated plate (8), whereon the scarce remnants of humidity finally condense, sliding down the inclined plane of the second perforated plate (8) towards the walls of the tank (1), wherealong, as indicated, they slide down towards the funnel (10) disposed at the bottom of the tank (1), where the condensed body of water is accumulated. The dry vapour flows out of the upper end (14) of the vapour extraction duct (6) towards a point of application and the lower bevelled end (7) prevents the production of a suction effect, due to the forced circulation of the vapour, near the accumulated body of water that could give rise to carry-over thereof.

The (8) water vapour conditioning-separating device of the present invention may be disposed at any location of a vapour piping facility, although, understandably, and in order to avoid small final condensations, it will preferably be located as close as possible to the spot of vapour application. The number of orifices of the perforated plates (5, 8) may vary widely in accordance with the volume of vapour that must circulate therethrough.

Likewise, the walls of the tank (1) may have the desired thickness and resistance in order enable application in pressurised circuits.

Lastly, it should be noted that, while express reference is made in the foregoing to the drying or treatment of water vapour, the device may equally be applied to the treatment of any other fluids, for example for the separation of water or oil in pneumatic circuits, without having to essentially vary the construction described.

1. Water vapour conditioning-separating device comprising a tank for acting as a condensation chamber,
the device being characterised in that it further comprises a vapour inlect duct disposed on the upper part of the tank,
wherein the inflow of vapour to the tank is carried out tangentially to the wall of said tank, flowing into an upper expansion enclosure of said tank, wherein the upper expansion enclosure is closed along the bottom by a filtering mass contained between two first perforated plates that jointly determine, together with the filtering mass, a labyrinthine passage for the circulating vapour, also comprising a treated vapour extraction duct that passes through the assembly formed by the filtering mass and the first perforated plates.

2. The device of claim 1, wherein the treated vapour extraction duct comprises a lower end disposed at a certain distance from the bottom of the tank, and an upper end wherethrough dry vapour flows out.

3. The device of claim 2, further comprising a second perforated plate having inclined walls sloping downward towards the walls of the tank which is disposed under the first perforated plates and above the lower end of the treated vapour extraction duct.

4. The device of claim 3, wherein the first and second perforated plates comprise orifices that, in turn, comprise protruding necks having irregular edges forming points that determine condensate drop formation spots.

5. The device of claim 4, wherein the protruding necks of the orifices of the first perforated plates are disposed under the first perforate plates in the direction of circulation of the vapour.

6. The device of claim 5, wherein the protruding necks of the second perforated plate are disposed above the second perforated plate in the opposite direction to that of circulation of the vapour.

7. The device of claim 3, wherein the first and second perforated plates comprise a series of notches along their peripheral edge for the condensed water to slide down the walls of the tank towards the bottom thereof.

8. The device of claim 2, wherein the lower end of the treated vapour extraction duct bevelled.

9. The device of claim 1, wherein the tank comprises a funnel at the bottom thereof and a purge duct adjacently disposed to the funnel.

10. The device of claim 9, further comprising a purge valve that can be coupled to the purge duct.

11. The device of claim 2, wherein the upper end wherethrough the dry vapour flows out is disposed in diametrical opposition to the vapour inlet duct.

12. The device of claim 4, wherein the first and second perforated plates comprise a series of notches along their peripheral edge for the condensed water to slide down the walls of the tank towards the bottom thereof.

13. The device of claim 5, wherein the first and second perforated plates comprise a series of notches along their peripheral edge for the condensed water to slide down the walls of the tank towards the bottom thereof.

14. The device of claim 6, wherein the first and second perforated plates comprise a series of notches along their peripheral edge for the condensed water to slide down the walls of the tank towards the bottom thereof.

15. The device of claim 3, wherein the lower end of the treated vapour extraction duct is bevelled.

16. The device of claim 4, wherein the lower end of the treated vapour extraction duct is bevelled.

17. The device of claim 5, wherein the lower end of the treated vapour extraction duct is bevelled.

18. The device of claim 6, wherein the lower end of the treated vapour extraction duct is bevelled.

19. The device of claim 7, wherein the lower end of the treated vapour extraction duct is bevelled.

20. The device of claim 3, wherein the upper end wherethrough the dry vapour flows out is disposed in diametrical opposition to the vapour inlet duct.
